(19) United States
(12) Patent Application Publication
(10) Pub. No.: US 2004/0039673 A1
(43) Pub. Date: Feb. 26, 2004

(54) Method, system, and computer program product for summarizing an implied volatility surface

(76) Inventors: Matt Amberson, Chicago, IL (US); Myron Wood, Chicago, IL (US)

Correspondence Address: BARNES & THORNBURG, P.O. BOX 2786, CHICAGO, IL, 60690-2786, US

(21) Appl. No.: 10/259,102

(22) Filed: Sep. 27, 2002

Related U.S. Application Data
(63) Continuation-in-part of application No. 10/223,549, filed on Aug. 19, 2002.

(51) Int. Cl. G06F 17/60

(52) U.S. Cl. 705/36

(57) ABSTRACT

Disclosed is a method, system, and computer program product for summarizing an implied volatility surface. The method includes steps to retrieve options-related data for a selected option chain, calculate the implied volatilities and other relevant values that represent a theoretical implied volatility surface and displaying a table containing values thereof, contemporaneously displaying a table representing the market implied volatility surface, and comparing the two tables to determine an advantageous market transaction.

This application is a continuation-in-part of U.S. Ser. No. 10/223,549 filed Aug. 15, 2002.

### BACKGROUND AND SUMMARY

The present disclosure related to a system, method, and computer program product for summarizing an implied volatility surface for a series of options for a particular security.

Volatility calculations are useful when a trader is using the Black and Scholes Model or variations thereof because all such models call for the trader to make a calculated assumption of the security's volatility. Many methods exist for calculating the volatility of a particular security, such as Close-to-Close methods which use the last price of the trading day when calculating volatility. Another method, known as Parkinson's Volatility, uses the highest and lowest prices from each day for calculating volatility. Other methods including the Garman & Klass method also base their calculation on various selected values that occur during selected trading intervals. Another method for calculating volatility is disclosed in co-pending U.S. patent application Ser. No. 10/223,549, which is hereby incorporated by reference.

In one method of options trading, a trader calculates a theoretical value of an option. If a discrepancy is found between the trader's theoretical value and the current trading value, a trader may take a position in the option hoping to profit when the option reaches the trader's theoretical price. However, as the price of an underlying security, for example stocks or futures, changes, the trader must make adjustments to his position to retain the potential profit defined by the difference in the current trading price and the trader's theoretical option value. The volatility figure used to value the option position impacts the price and quantity of the underlying security that the trader will buy or sell for the purpose of maintaining or adjusting the position's profit potential and risk parameters. Such a position may be known as a delta position. The volatility figure also impacts the price, quantity, and series of the option contracts that are traded for the purposes of maintaining or adjusting the position's profit potential and risk parameters.

For a particular security, there is available a plurality of options at various strike prices and expiration dates, wherein the strike price represents the price at which the option holder must buy or sell the underlying security if the option is exercised and wherein the expiration date is the date on which the option expires. The plurality of options is known as the security's “option chain.” It is useful to traders to have a macro view of the implied volatilities for each option chain. A graphical or tabular view of data points representing the implied volatilities for each option in the option chain is known as an “implied volatility surface.” An implied volatility surface is a 3-dimensional surface where the independent variables are time to expiration and option delta and the dependent variable is implied volatility. The present invention provides for faster, easier, more objectively accurate system and method for computation and manipulation of the implied volatility surface.

Prior art methods of graphing a volatility surface include placing the strike price or strike price divided by underlying price (“normalized strike”) on one axis and the implied volatility on a second axis. To option traders adjusting their delta positions as described above, what may be even more important than the relationship between the strike and implied volatility is the relationship between a particular strike's delta and the implied volatility. For this reason, the present system, method, and computer program product discloses a novel approach to viewing the volatility surface by graphing the implied volatilities of the strikes against their respective deltas. The present system also provides for multi-month viewing of such a matrix by graphing multiple months on one graph, referred to herein as an “inter-intra-month view” which juxtaposes an implied volatility versus delta relationship across several expiration months.

One prior art method uses all available options within the option chain to develop the volatility surface. Such a method presents a problem because options such as those having very small deltas, may be characterized as having erratic trading behavior and may not have bid prices. The result of including such problematic options is a less stable measurement of the implied volatility surface and potentially losing hedging strategy. There is therefore a need for a methodology that filters out these problematic options when calculating the volatility surface.

Also, in calculating a volatility surface, prior methods fail to provide a user with the ability to easily manipulate volatility assumptions having to do with increases in volatility when a company declares earnings. Typically, because there exists a variety of speculations about the dollar amount of a particular earnings announcement, volatility around that earnings announcement increases. Similarly, securities, and their associated options, experience volatility increases and decreases during certain predictable days or seasons within a year. A system that provides for inclusion and easy manipulation of both an earnings effect and seasonal effects would be useful for traders making volatility and pricing predictions.

Current methods for summarizing volatility surfaces include methods for measuring at-the-money implied volatility using arbitrary data points within an option chain's data set. In that method, a formula is used that averages the implied volatilities of the call and put prices for three series of the same class that have strike prices that are closest in value to the current price of the underlying security. The use of arbitrary points within the class, and limiting data points to options with values closer to the price of the underlying asset, limits the accuracy of such calculations. A method is needed which objectively considers relevant data points and more accurately represents the volatility surface.

Another current method is to only consider one strike that is closest to the price of the underlying asset. Use of only one strike produces a less stable measurement of at-the-money volatility than using more of the option-related data set. Another variation of these prior art methods selects a particular delta value, such as 0.3, and considers only the call with 0.3 delta, the put with the −0.3 delta, and the call and put with 0.5 absolute delta in averaging the implied volatility.

In addition, prior art methods have failed to relate each month or class with all other options for the same underlying asset in an efficient, easily readable system, method, and computer program product. For example, the general level, steepness, and curvature of a graph representing the volatility surface for a particular month are useful to traders, but are not available using prior art methods. Also, the averaging methodologies of prior art methods fail to take into account a more complete set of parameters that describe the volatility surface.

Briefly, and in accordance with the foregoing, disclosed is a method, system, and computer program product for summarizing an implied volatility surface. The method includes steps to retrieve options-related data for a selected option chain, calculate the implied volatilities and other relevant values that represent a theoretical implied volatility surface and displaying a table containing values thereof, contemporaneously displaying a table representing the marked implied volatility surface, and comparing the two tables to determine an advantageous market transaction.

The method also allows a user to manipulate assumptions to adjust the theoretical implied volatility surface. The assumptions and relevant values more accurately describe the volatility surface and include but are not limited to: a 20 trading day implied volatility, an infinite implied volatility, an earnings effect, a seasonal effect, a current slope, a current derivative, a long term slope, and a long term derivative.

Also disclosed is computer program product embodiment of a method for summarizing an implied volatility surface which includes a number of software modules used to retrieve options-related data for a selected option chain, calculate the implied volatilities and other relevant values that represent a theoretical implied volatility surface and displaying a table containing values thereof, contemporaneously displaying a table representing the marked implied volatility surface, and comparing the two tables to determine an advantageous market transaction.

Also disclosed is a signal embodied in a carrier wave which includes data used to summarize an implied volatility surface.

Additional features will become apparent to those skilled in the art upon consideration of the following detailed description of drawings exemplifying the best mode as presently perceived.

### BRIEF DESCRIPTION OF THE DRAWINGS

The detailed description particularly refers to the accompanying figures in which:

FIG. 1 is a diagrammatic flowchart showing an overview of a method for summarizing a volatility surface;

FIG. 2 is a diagrammatic view of a series of steps to filter option series by delta and Rip Value;

FIG. 3 is a diagrammatic view of a series of steps to calculate basic call/put at-the-money volatilities;

FIG. 4 is a tabular representation of the volatility surface and related data;

FIG. 5 is a graphical view of a volatility surface for a particular month;

FIG. 6 is a graphical view of an inter-intra-month graph juxtaposing the volatility surfaces of five months in one graph; and

FIG. 7 is a simplified diagrammatic view of a system for summarizing a volatility surface and creating a signal embodying volatility surface-related data.

### DETAILED DESCRIPTION OF THE DRAWINGS

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

This disclosure makes references to several terms in the securities industry that should be considered according to the following descriptions. A security or underlying asset involved with system, method, and computer program product described herein, may include but are not be limited to following instruments: equity, bonds, loans, private placements, forward contracts, futures contracts, swaps, forward swaps/delayed start swaps, break forwards, calls, puts, straddles/strangles/butterflies, reverse floating rate loan/bull floating rate notes, dual currency bonds, callable/puttable bonds, puttable stock, bond with warrant, convertible bonds, liquid yield option notes, commodity-linked bonds, auction rate notes/debentures, collateralized mortgage obligations/real estate mortgage investment conduits, commercial real-estate backed bonds, credit enhanced debt securities, dollar bills, foreign exchange paper, floating/rate sensitive notes, floating rate tax-exempt revenue bonds, increasing rate notes, indexed currency option notes or principal exchange rate linked securities, caps/floors/collars, interest rate reset notes, mortgage pass-through certificates, negotiable certificates of deposit, adjustable tender securities, puttable/extendable notes, real yield securities, receivable pay-through securities, remarketed reset notes, stripped mortgage backed securities, stripped treasuries/municipals, variable coupon renewable notes, variable rate renewable notes, yield curve/maximum rate notes, adjustable rate preferred stock, auction rate preferred stock, convertible adjustable preferred stock, remarketed preferred stock, single point adjustable rate stock, state rate auction preferred stock, variable cumulative preferred stock, adjustable rate convertible debt, convertible exchangeable preferred stock, convertible reset debentures, debt with mandatory common stock purchase contracts, exchangeable preferred stock, synthetic convertible debt, zero coupon convertible debt, and puttable common stock.

The method, system, and computer program product also refer to collection option-related data about certain options. The term “Options” as used herein may include but are not limited to the following types: vanilla options, Asian options, barrier options, binary options, chooser options, compound options, crack/spread options, currency translated options on U.S. or foreign “stripped” government securities divided into two or more instruments of principal and interest or price and dividend, options on stripped corporate, agency, and municipal securities, notes, bills and certificates of deposit, options on callables, and options on odd-first, -last, -middle, or securities with varying coupon/dividend periods.

The method may be embodied in a computer program product for use with a general purpose computer of known construction. The software programmed to perform the steps of the method or which represent the computer program product may be written in one or more software modules. The term “module” referenced in this disclosure is meant to broadly cover various types of software code including but not limited to routines, functions, objects, libraries, classes, members, packages, procedures, or lines of code together performing similar functionality to these types of coding. The steps may be performed with a stand-alone program written in languages such as C++, Java, Fortran, Visual Basic or be implemented using a scripting language which supplements an off-the-shelf software package or spreadsheet 214 such as Microsoft Excel.

Users of the disclosed method may include, but should not be limited to market participants in the options-related industry, such as, for example, brokers, traders, investors, risk managers, analysts, etc. Advantageous information obtained by such person may be used in a variety of ways depending on their respective roles, such as making a trade for traders, or making a recommendation for analysts. For simplicity, market participants are referred to as “traders” and the advantageous options transactions shall generally be referred to as “trading” in this application.

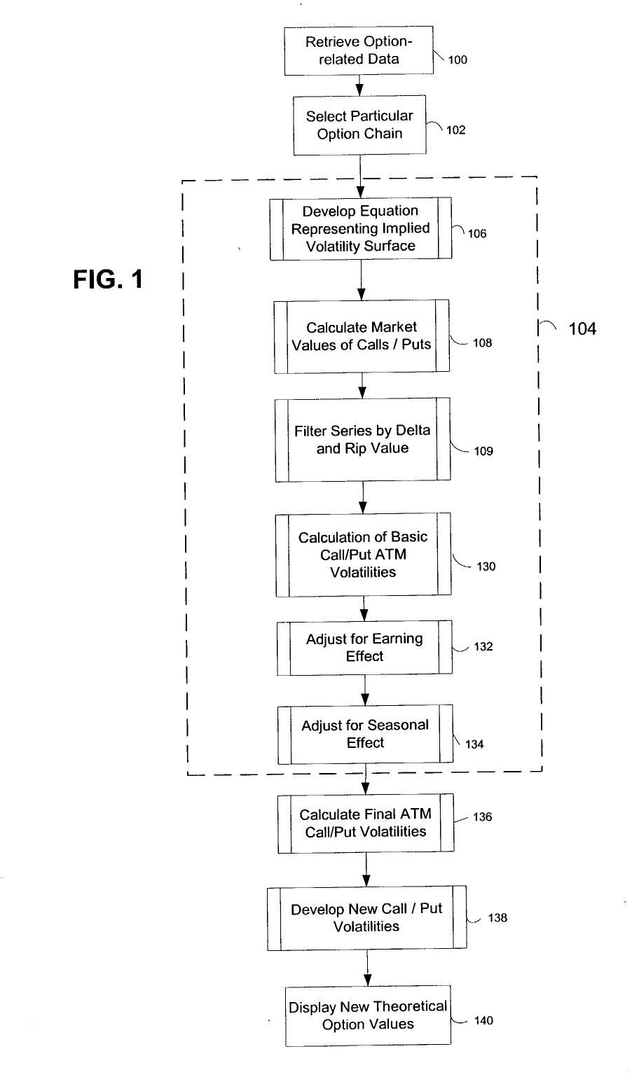

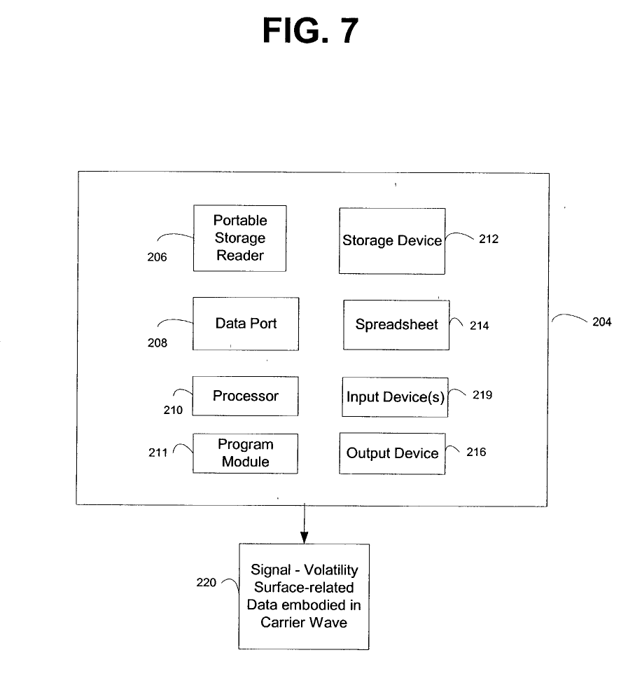

With reference to FIG. 1, options-related data is retrieved from a data source 100. If new data, for example recent ticker data, is being utilized, the data is retrieved from a data service such as, for example, Reuters, Bloomberg, or the New York Stock Exchange TAQ Database or other data provided over any communication means, such as, for example, a communication network such as the Internet or over a proprietary communication connection to these services. Historical data may also be utilized, in which case the data is retrieved from a storage device 212 (FIG. 7), such as, for example, a floppy drive, hard drive, tape drive, a CDR, or a CDRW. The options-related data may be for a set of securities or for one security in particular.

Option-related data may preferably include a last trade price, dividend yield, current interest rate, bid price, offer price, and shares per contract. The option-related data may also include business days to expiration, trading days to expiration, OPRA (Options Prices Reporting Authority) code, exchange listed symbol, exercise type, strike price, hedge price, spot price, dividends announced, dividends expected, price adjust, cash adjust, dollar value, bid size, ask size, high trade, low trade, net change, open interest, time of last trade and volume. A particular option chain 102 is then selected for use in the analysis. The option-related data for the selected option chain 102 is then used to develop a set of implied volatility surface-determining parameters 104. Although other methods may be used, the following in a preferred method for deriving the parameters 104.

If the data service provides indicates that there is no dividend yield or provides no information regarding a dividend yield, a default asset dividend yield is selected or a prior art method of calculating implied dividends is used. An advantageous figure for the default has been found to be, for example, 0% although other figures may be used. An intermonth curve may be defined using the following equations 106:

S=(t)^{-0.5}+(1_{INF})(1−t^{-0.5}) Equation 1

$$Equation 2 \text{:} S = \frac{{I}_{20} - ( {I}_{INF} ( 1 - {20}^{- 0.5} ) )}{{20}^{- 0.5}}$$

The variables shown in the above represent the following: I_{inf}: The longest-dated default-free interest rate quoted by the data service; S is the steepness factor, I₂₀: The 20 trading day default free yield or the default-free yield with the closest matching maturity; and where t is the time measured in number of trading days until expiration or if an option has less than 20 trading days to expiration, 20 days is used.

The next step to develop the parameters 104 is to calculate a market value 108 of the calls and puts in the option chain 102 which may be also referred to as a series 102. The market value 108 of a call is the average of bid and ask prices for a call. The market value 108 of a put is the average of the bid and ask prices for a put. This step is followed by one in which the series 102 is filtered 109 by delta and (rip value, described in more detailed below.

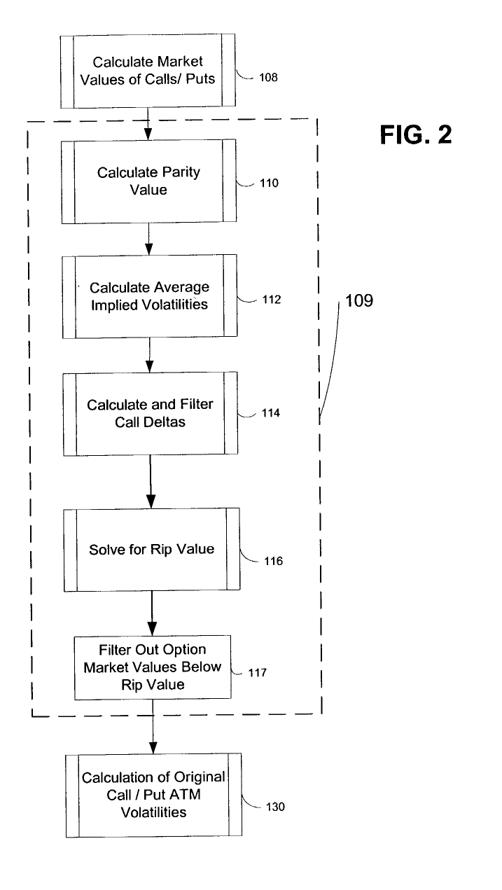

A shown in FIG. 2, a next step is to determine the parity value of each call and put in the option chain 102. Various methods and commercially available tools may be used to calculate parity values. An example of such a commercially available tool is Fintools, available from Montgomery Investment Technology Institute, which uses the industry-known Hull Model of Binomial Option Equation to calculate the parity value. One input called for by such tools or methods is an “almost-zero volatility” figure. A value of 0.0001% volatility has been found advantageous although other near-zero values may be used.

For each series, an average implied volatility (“AI Vol”) FIG. 112 is calculated. To perform this calculation, several tools, including Fintools, may be utilized. An assumption requested by the tool is for a “Market Option Price.” A maximum of the market value 108 and parity value 110 is used as the Market Option Price for purposes of using the Fintools tool. Call deltas 114 are then calculated using, for example, Fintools.

Filtering of the call deltas 114 used in the remainder of the calculations for determining the parameters 104 is performed to filter out certain options, for example, those having very small or very large absolute deltas, because measurement of their implied volatility is unreliable. One of the reasons for this unreliability is that the quotes for options having very small absolute deltas are often only one-sided, having only an offer price. An advantageous methodology for filtering out these options is to ignore strikes where either option has an absolute delta outside a lower limit to upper limit range. The preferred values are 0.15 for the “lower limit” and 0.85. for the “upper limit” however other values could be used. Other values may be used that are plus or minus 0.14 of the preferred values. Implied volatilities for an option chain are typically, but not necessarily, viewed in groups separated by expiration month. For calculation purposes, the remaining months in the option chain's life may be grouped into two groups. A first group is “current months” for months one to four, inclusive, and a second group is “long term months” for months subsequent to month four.

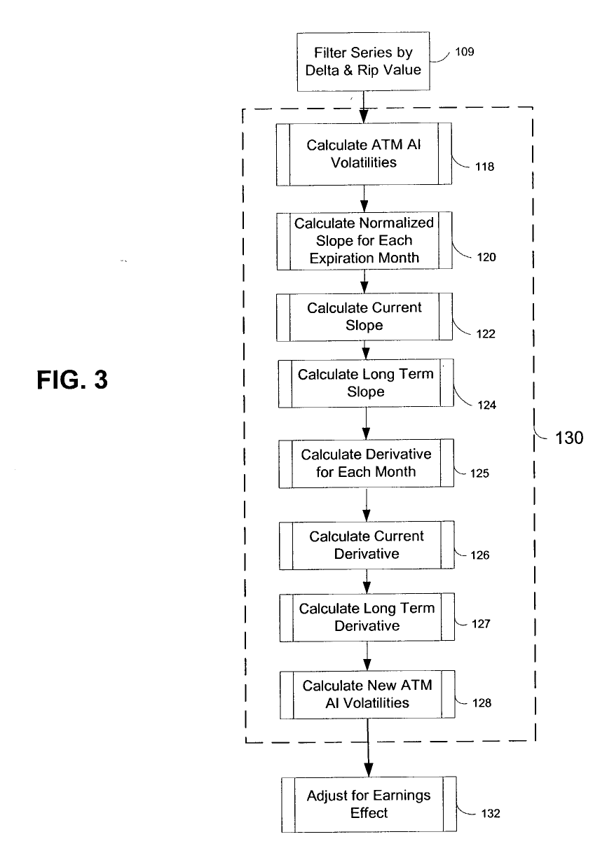

A “rip value” 116 is next calculated using the options-related data including: the calculated implied volatilities, a last price of the underlying asset, using a number of days until expiration, such as for example, 45 days, a default interest rate, and an underlying dividend yield. The rip value 116 is used to filter out strikes 117 exhibiting unreliable implied volatility measurement characteristics. Such behavior has been observed for strikes where the average of the bid and ask prices of the call or put is less than a “selected percentage”, for example 80%, of the rip value 116. In other application, the preferred range for the selected percentage may be 1% to 100%. The rip value 116 may be calculated by iteratively or recursively solving for a strike price that causes a put delta to be −0.25 with a tolerance of plus-or-minus 0.01. Other options are filtered out as well such as strikes that have no market price quotes. As shown in FIG. 3, next, the at-the-money average implied volatility 118, or ATM AI Vol, for each expiration month is calculated using the following equation:

$$Equation 3 \text{:} \frac{\sum ( {V}_{AI} \times {W}_{S} )}{\sum {W}_{S}}$$

where V_{AI} is the average implied volatility for each series and W_{S} is a weighting factor for each series. A weighting factor is used because options with strikes closest to the at-the-money strike have a greater effect on the volatility of the option chain 102. With this general purpose in mind, one method to calculate to the weighting factor is given by the equation:

$$Equation 4 \text{:} \frac{.50 - \vert c - .05 \vert}{2}$$

where “c” is the call delta for the series. The ATM AI Vol 118 is used to calculate a new theoretical call delta for each strike in the option chain 102. A relative AI Vol is then calculated where the AI Vol is divided by the applicable ATM AI Vol. The slope between adjacent strike pairs is calculated using the relative AI Vol as the dependent variable (y-axis) and the call delta as the independent variable (x-axis). Adjacent strike pairs consist of series that are of the same expiration month and whose strike prices are only one minimum strike increment apart. An example of a minimum strike increment is $5. The rate at which the slopes between adjacent strike prices changes with respect to call delta is calculated using the average call delta of adjacent strike pairs as the independent variable. This derivative 125 may be calculated by grouping all adjacent strike pairs into the current months and long term months, setting the slope of each adjacent strike pair as the dependent variable, setting the average call delta of each adjacent strike pair as the independent variable, and calculating the least squares slope of these arrays. The slope of the current month array is the “current derivative” 126 and the slope of the long term month array is the “long term derivative” 127. For better statistical accuracy, slopes for months with less than a reliable number of data points, such as, for example, 5 data points, are assigned a default value, such as, for example 0.00008, although the default value may ultimately range from 0 to the slope value. A “slope normalization factor” 120 is then calculated for each strike pair by subtracting 0.5 from the average call delta of each pair of adjacent strikes, the difference of which is multiplied by the derivative. For the derivative, the current derivative is used for strike pairs whose expiration falls within the current months and the long term derivative is used for strike pairs whose expiration falls within the long term months. The “normalized slope” 120 is then calculated for each strike pair by subtracting the “slope normalization factor” from the slope. The normalized slope 120 is then set to a lower limit, such as, for example, −0.002 if the normalized slope 120 is less than the lower limit, or to an upper limit, such as, for example 0.02, if the normalized slope 120 is greater than an upper limit.

The average of the normalized slopes 120 of all adjacent strike pairs whose expiration falls within the current months is the “current slope” 122 and the average for the normalized slopes 120 of all adjacent strike pairs whose expiration falls within the long term months is the “long term slope” 124. The average of all normalized slopes 120 is also calculated for each expiration month. These averages are “month 1 slope”, “month 2 slope”, “month 3 slope”, etc.

The method is now able to calculate a new theoretical set of option at-the-money average implied volatilities using the slopes and derivatives calculated from the above sets. The filtering steps described above cause these calculated slopes and derivatives to more accurately describe the shape of the implied volatility surface of the option chain 102. Knowing this more accurate and reliable volatility allows for reversing the calculation to determine a theoretical set of values. Where a discrepancy exists between the theoretical value and the market value, a trader confident in the trader's assumptions and in the filtering methodology described above, may expect to make a profit or advantageously adjust an option position, when trading to take advantage of that discrepancy. The new at-the-money implied volatility may be calculated using the following equation:

$$Equation 5 \text{:} {A}_{NEW} = \frac{A}{1 + [ [ \frac{c - .50}{2} D + S ] [ c - 50 ] ]}$$

where A_{NEW} is the AI Vol, C is the call delta, D is the derivative, and S is the slope. A weighted average of all A_{NEW} in each expiration month is then calculated, which includes a weighting factor for the reliability purposes described above. This weighted average of new AI Vols is used to calculate a new ATM AI Vol 128 using the same equation for calculating an ATM AI Vol 128 described above.

The above slopes, derivatives, and new ATM AI Vols 128 are then used to calculate theoretical market implied volatilities for every strike using the methods above in reverse. The theoretical market implied volatilities can be calculated using the equation below:

$$Equation 5 a \text{:} {Vol}_{MKTTHEORETICAL} = ( {V}_{{ATMAI}_{T}} ) ( 1 + ( S + \frac{( D ) ( c - .05 )}{2} ) ( c - .50 ) )$$

where the Vol_{MKTTHEORETICAL} is the theoretical market implied volatility; V_{ATMAlt} is the new ATM AI Vol calculated above.

Using widely available methods, such as Fintools, the theoretical market value of each option in the option is then calculated using the Vol_{MKTTHEORETICAL} as the volatility input.

To calculate the out-of-the-money call and put effects, the theoretical market value is subtracted from the market value calculated above for each strike. For the options with call deltas, between a selected range, such as, for example 0 and the lower limit selected above, the average of these differences is calculated. This average is the out-of-the-money call effect referred to hereinafter as the “OTM call effect”. For the options with call deltas between outside the selected range, such as, in keeping with the example above, 1 and the upper limit, the average of these differences is calculated. This average is the out-of-the-money put effect “OTM put effect.”

Twenty trading day market implied at-the-money volatility, hereinafter referred to as VATM20, and infinite market implied at-the-money volatility, hereinafter referred to as VMINF, may be calculated using iterations that continue until the values of the VATM20 and the VMINF yield the minimum sum of squared errors. The errors are calculated to be the difference between the new ATM AI Vols for each month and the implied volatility of an inter-period curve at a particular expiration date. An example of such a period is a trading day, although other periods may be used. For simplicity, this curve will be referred to as an “internonth curve.” The intermonth curve may be graphed from the following equation:

St^{0.5}+V_{MINF}(1−t^{-0.5}) Equation 6

where V_{MINF} is a ATM AI Vol that the market appears to be using for setting the volatility of a theoretical class that has a time to expiration close to infinity; where t is time to expiration, expressed in trading days, calendar days, trading hours, trading minutes or trading seconds, or is equal to a “minimum time” if the time to expirationis less than the minimum time. For minimum time to expiration, the preferred units are trading days and preferred length is 20 trading days, although the range may be anywhere from 1 to 30 trading days.; and where S is a “steepness factor” calculated using the following quotient:

$$Equation 7 \text{:} \frac{⌊ {V}_{ATM 20} - ( {V}_{MINF} ) ( 1 - {20}^{- 0.5} ) ⌋}{{20}^{- 05}}$$

where V_{ATM}20 is the market implied ATM volatility of a theoretical option class that is constantly 20 trading days to expiration hereinafter referred to as the “front-month at-the-money implied volatility”. To modify the steepness factor formula for a front-month at-the-money implied volatility that is constantly some minimum time from expiration, 20 is replaced by that number throughout the formula.

In performing the method, a trader may also wish to override the parameters 104 including the V_{ATM20} and the Vol_{MINF}. The trader may base their adjustments to these parameters 104 on a number of assumptions such as how they expect the market to move or recent intra-period volatility.

The methods above are then used in reverse to calculate “Basic Call/Put ATM Volatilities” for each expiration month that should be utilized, incorporating any overrides made by the trader or a market making system. To calculate these “Basic Call/Put ATM Volatilities” 130 for each month, an equation representing the intermonth curve is used:

ATMₜ=Sₒ(t)^{-0.5}+ATM_{INF}(1−t^{-0.5}) Equation 8

where “t” is the time to expiration in each month, with a minimum of 20 days; where ATM_{INF} is an infinite ATM call/put value selected by a user or set from a default by a market making system; and where So is the original steepness factor calculated by equation:

$$Equation 9 \text{:} \frac{⌊ {ATM}_{ 20} - ( {ATM}_{INF} ) ( 1 - {20}^{- 05} ) ⌋}{{20}^{- 0.5}}$$

where ATM20 is the user-defined 20 day ATM Call/Put Vol. Where the preferred units and length are modified in the Equation 7, the same modifications should be made to Equation 9. Referring to FIG. 1, the method may also include the ability to adjust the basic ATM Call/Put Vols for each month using an earnings effect 132 or seasonal effect 134. These adjustment factors are represented as a starting date, a number of days over which to apply the adjustment, and a magnitude or percentage of the adjustment. Adjustment factors may be expressed as the ratio of the volatility during the selected period divided by a basic ATM Call/Put Vol for that period. As a default for number of days for the earnings effect, 2 days may be preferably used which include the day the earnings are announced, referred to hereinafter as the announcement date, and the day following the announcement date, although other quantities may be used such as, for example from 1 day to 30 days before and or after the earnings announcement date. Announcement dates are available publicly, and in a computer-aided embodiment of this method, may be retrieved from a data service.

Subsequent announcement dates may also be set a fixed number of days after an initial announcement date or may be retrieved from a data service. An example might be setting the second announcement date to be 91.25 days after the first date, with a third announcement date set to be 182.5 days after the initial announcement date and additional announcement dates on incremental number of dates thereafter. The effect of all earning dates may be taken into account to determine the appropriate earnings effect 132. The announcement date is considered to affect an option if the announcement date occurs on the last trading day prior to expiration or prior to that day.

Similarly, a seasonal effect 134 may expressed by a number of days over which to apply the adjustment, a starting date, and a percentage or magnitude. The seasonal effect 134 affects a particular class for the minimum of the length of the seasonal effect and the difference between the seasonal effect start date and the expiration date. This length of time that the seasonal effect affects the a particular class cannot be negative. The magnitude of the effect is calculated using the following formula:

$$Equation 10 \text{:} {E}_{s} = \frac{( {F}_{A} ) ( {ATM}_{t}^{2} ) ( D ) + ( {ATM}_{t}^{2} ) ( N )}{( {T}_{DAYS} )}$$

where E_{S} is the seasonal effect 104; F_{A} is an adjustment factor; ATMt is the basic ATM Call/Put Vol; D is the number of days the seasonal effect affects the selected month; N is the number of days to expiration in the month that are not affected by the special period of volatility; and T_{DAYS} is the total number of days to expiration in the month that includes the special period of volatility.

These two adjustments are used to calculate a Final ATM Call/Put Vol 136 which is calculated by the equation:

V_{FINALt}=\sqrt{E_{S}−ATMₜ²}+ATMₜ Equation 11

where VFINALt is the Final ATM Call/Put Vol 136.

Based on these parameters, the method now calculates new call and put volatilities 138. These new volatilities can be used to calculate new theoretical values 140 for the options in the option chain 102. A trader may trade on advantageous discrepancy between the market price and theoretical value. The theoretical volatilities are calculated using the following formula:

$$Equation 12 \text{:} {Vol}_{THEORETICAL} = ( {V}_{{FINAL}_{t}} ) ( 1 + ( S + \frac{( D ) ( c - .05 )}{2} ) ( c - .50 ) )$$

Using the theoretical volatilities, new option theoretical values may be calculated using known option pricing formulas or commercial available tools, such as, for example, Fintools. Where such tools request or utilize user assumptions or inputs, the method will use data service-provided values unless a trader has overridden those values in the course of using the above method. These new option theoretical values can be adjusted based on the OTM Call Effect and OTM Put Effect measured above or these values can be overridden by the trader or by a market making system.

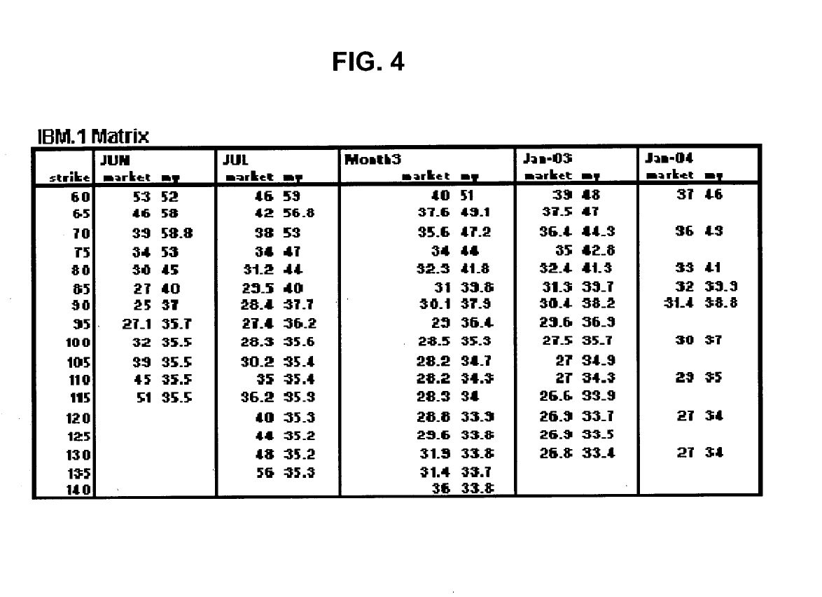

After volatility surface determinative values have been calculated, the programmed computer system may be utilized to display such values. In one embodiment, the values are displayed in tabular or grid format. Such display allows for easy comparison of the series of strikes found in the option chain 102. In a preferred tabular format, as seen in FIG. 4, strikes price as displayed in a column followed by other data, including AI and Vol_{THEORETICAL}, in columns to the right of the strike price column, although any ordering of this data may be used.

The other useful variables such as 20 day and infinite implied volatility, and theoretical volatilities 138, and earnings and seasonal effect 134, 136 for each month are included in the table. Information about the selected underlying asset is also included, for a trader's additional convenience. Black-Scholes formula related “Greeks” such as the delta, theta, etc. may also be included.

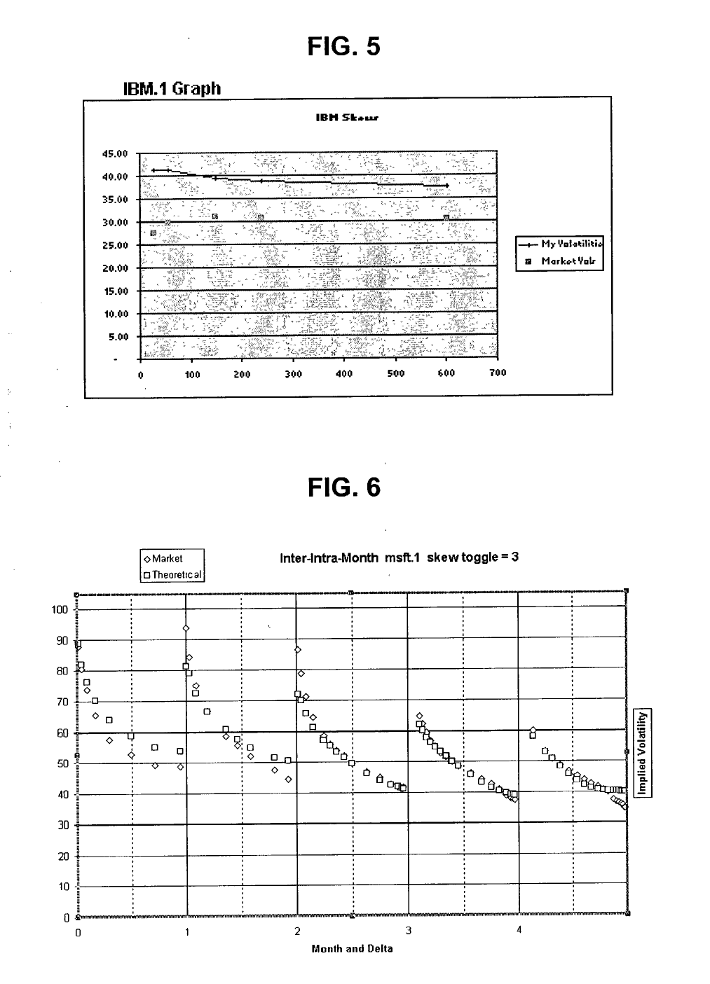

As shown in FIG. 5, in another embodiment, the theoretical options volatilities 138 are plotted graphically on a graph where, one axis, such as the X-axis, represents the option's delta and where a second axis, such as the Y-axis, represents the implied volatility of the option represented by the data points. Such an arrangement is advantageous for traders because it visually juxtaposes the market and theoretical option volatilities allowing the trade to immediately spot a discrepancy. The graph is also helpful for the trader to check the accuracy of their calculations because a wildly different theoretical skew might indicate some mistake with an inputted or overridden value.

Another embodiment of this graph, as seen in FIG. 6, is to compose multiple months onto one graph by dividing one axis into intervals representing various expiration months. It should be noted that designating the X and Y axes as described above may be reversed. Other axis designations may be used.

As a simple interface for entering an overriding value, or changing assumptions such as, for example, seasonal effects, a trader may simply type a new value into the grid having a commonly known spreadsheet interface, or drag a point on a computer-generated theoretical graph using an input device such as a mouse. Such dragging would result in the dependent theoretical value being recalculated almost instantaneously. In this manner, a trader may experiment or adjust the various variables as many times as desired and review an unlimited number of theoretical grids and graphs.

Referring now to FIG. 7, a system 204 for implementing the above method includes a portable storage reader 206 such as, for example, a floppy disk, CD-ROM, CDR, DVD, DVDr, DVD+RW, tape, memory stick, or removal hard drive containing historical tick data. This portable storage reader 206 communicates with a processor 210 to perform a number of calculations to determine the volatility surface. The system 204 may also include a spreadsheet program 214 or program module 211. A storage device 212, such as, for example, a floppy drive, hard drive, tape drive, a CDR, or a CDRW, is also included for recording variables, parameters, and for other purposes to retrieve and calculate needed information. Tick data required for this calculation may be received via CD-ROM or other portable storage media from a data service such as Reuters, Bloomberg, or New York Stock Exchange TAQ Database or over a communications network such as the Internet by a data port 208, such as, for example, a network card, a serial port, parallel port, firewire port, or network card configured to communicate with a network wirelessly.

The system 204 also includes an output device 216, such as, for example, a monitor or printer, or network interface which prompts the user for calculation-determinative assumptions, i.e. earning effect 132, seasonal effect, 134, etc., and to output volatility surface in tabular or graphical format being determined. The system 204 also includes one or more input devices 219, such as, for example, a keyboard and mouse, to allow a user to communicate with the system 204.

The system 204 may also include a translating device, such as for example, a compression chip on a network card, for translating volatility surface-related data into a digital data signal 220. The data signal 220 may be transmitted via a carrier wave remotely to a general purpose computer. Upon receiving the data signal 220, the volatility surface-selected data contained therein may be used for one or more of the purposes described above. For example, the data signal 220 may be received by a remote computer which is programmed to buy or sell options. The remote computer might receive the theoretical option values 140 in the data signal 220, and execute a buy or sell when there is a favorable discrepancy between the theoretical option values and the market option market values.

The data signal 220 may be configured to operate over commonly used network or communications protocols, such as TCP/IP or IPX. With such protocols, the system 204 processes the data signal 220 into a compressed signal of various length codewords, encrypts the compressed signal, and transmits compressed and encrypted signal to the remote computer. The remote computer is programmed to decompress and decrypt the data signal 220 so that the volatility surface-related data may be utilized.

A computer program product, which may distributed by, for example, a disk, CD-ROM, DVD, or via download, may also be an embodiment of the above method. The computer program product may be composed of a number of modules programmed to request the inputs, communicate with a processor to process the calculations, communicate with an output device to display the results, and to perform the other functions needed to summarize the volatility surface.

With the functional descriptions provided above, one skilled in the art can use a variety of software authoring products, such as, for example, a programming language like C++, to produce code to perform the volatility surface-determinative functions. The computer program product may also be designed by customizing a commercially available spreadsheet, such as by defining a number of cell formulas, or by supplementing the spreadsheet with code, such as Visual Basic. Excel from Microsoft is an example of one such customizable spreadsheet program.

While preferred embodiments of the disclosure are shown and described, it is envisioned that those skilled in the art may devise various modifications and equivalents without departing from the spirit and scope of the disclosure as recited in the following claims.

What is claimed is

1. A computerized method for assisting option value forecasting comprising the steps of:
(a) retrieving option-related data for a selected option chain;
(b) calculating a plurality of parameters that summarize a theoretical implied volatility surface;
(c) displaying a first table representing the theoretical implied volatility surface and contemporaneously showing a second table representing a market implied volatility surface; and
(d) comparing the first table and the second table to determine an advantageous options transaction.

2. The method of claim 1, wherein the plurality of parameters includes: a plurality of at-the-money volatilities; a plurality of intra-month slopes; a plurality of intra-month derivatives; and a plurality of out-of-the-money call and put effects.

3. The method of claim 2, wherein the plurality of at-the-money volatilities are summarized by an intermonth curve defined by a 20 trading at-the-money volatility, an infinite at-the-money volatility and a steep factor.

4. The method of claim 2, wherein the plurality of parameters further includes: an implied interest rate and an implied dividend.

5. The method of claim 1, wherein the plurality of parameters includes a seasonal effect.

6. The method claim 1, wherein the plurality of parameters includes an earnings effect.

7. The method of claim 2, wherein a series of calls and puts used to calculate an at-the-money volatility is limited to those calls and puts with delta values greater than or equal to a lower limit and less than or equal to an upper limit wherein call or put values outside the lower and upper limits exhibit unreliable implied volatility measurement behavior.

8. The method of claim 7, wherein the lower limit is 0.15 and the upper limit is 0.85.

9. The method of claim 1, wherein the options-related data includes:
(a) for an underlying security: a last sale price, expected dividend dates, expected dividends, expected earnings announcement date;
(b) for each call and put option in the selected option chain: a bid price, an offer price, a strike price, an expiration date and a number of shares per contract; and
(c) for all underlying securities, calls, and puts: a short-term risk-free interest rate and a long term risk-free interest rate.

10. A method of displaying a volatility surface graphically comprising the steps of:
(a) defining a first axis to represent a delta of each of a plurality of options in a selected option chain;
(b) defining a second axis to represent an implied volatility of each of a plurality of options in the selected option chain; and
(c) displaying a first graph in which data points coinciding with values on the first axis and second axis are plotted.

11. The method of claim 10, further comprising the step of displaying a second graph having a third axis divided into a plurality of intervals defining a plurality of sub-axes, each individual interval of the plurality of intervals representing an expiration month, each sub-axis in the plurality of sub-axes representing the delta of a plurality of options in the selected option chain for the expiration month associated with the interval, and the second graph having a fourth axis representing the implied volatility of the plurality of options in the selected option chain.

12. A method of calculating an at-the-money volatility using a series of calls and puts, the series being limited to calls and puts being limited to those with market values greater than or equal to a calculated rip value, wherein the calculated rip value is selected to filter out options whose cost exceeds a total potential hedging benefit.

13. The method of claim 12, wherein the calculated rip value is a theoretical value of an option with 45 days to expiration, having a delta of 0.25, and having a volatility equal to an implied volatility of a similar option traded in the market or the historical volatility of the underlying asset.

14. A method for adjusting a security's theoretical implied volatility surface using a seasonal effect comprising the steps of:
(a) selecting a percentage to adjust the security's volatility;
(b) selecting a starting date at which to apply the percentage;
(c) selecting a number of days over which to apply the percentage; and
(d) adjusting the security's implied volatility surface starting at the starting date, for the number of days, at the percentage.

15. A method of adjusting a security's volatility using an earnings effect comprising the steps of:
(a) selecting a percentage to adjust the security's volatility;
(b) determining an earnings announcement date and selecting a starting date;
(c) selecting a number of days over which to apply the percentage; and
(d) adjusting the security's volatility starting at the starting date, for the number of days, at the percentage.

16. A system for assisting option value forecasting comprising: a storage device, a means for receiving data; memory; a program module; an output device; and a processor responsive to a plurality of instructions from the program module, being operative to:
(a) retrieve option-related data for a selected option chain from memory;
(b) calculate a plurality of parameters that summarize a theoretical implied volatility surface and storing the plurality of parameters on the storage device; and
(c) display a first table representing the theoretical implied volatility surface and contemporaneously display a second table representing a market implied volatility surface on the output device.

17. The system of claim 16, wherein the plurality of parameters includes: a plurality of at-the-money volatilities; a plurality of intra-month slopes; a plurality of intra-month derivatives; and a plurality of out-of-the-money call and put effects.

18. The system of claim 17, wherein the plurality of parameters includes a seasonal effect.

19. The system of claim 17, wherein the plurality of parameters includes an earnings effect.

20. The system of claim 17, wherein a series of calls and puts used to calculate an at-the-money volatility is limited to those calls and puts with delta values greater than or equal to a lower limit and less than or equal to an upper limit wherein call or put values outside the lower and upper limits exhibit unreliable implied volatility measurement behavior.

21. A computer program product for use with a computer, said computer program product comprising:
(a) a module for retrieving option-related data for a selected option chain;
(b) a module for calculating a plurality of parameters that summarize a theoretical implied volatility surface; and
(c) a module for displaying a first table representing the theoretical implied volatility surface and contemporaneously displaying a second table representing a market implied volatility surface.

22. The computer program product of claim 21; wherein the plurality of parameters includes: a plurality of at-the-money volatilities; a plurality of intra-month slopes; a plurality of intra-month derivatives; and a plurality of out-of-the-money call and put effects.

23. The computer program product of claim 22, wherein the plurality of parameters includes a seasonal effect.

24. The computer program product of claim 22, wherein the plurality of parameters includes an earnings effect.

25. The computer program product of claim 22, wherein a series of calls and puts used to calculate an at-the-money volatility is limited to those calls and puts with delta values greater than or equal to a lower limit and less than or equal to an upper limit wherein call or put values outside the lower and upper limits exhibit unreliable implied volatility measurement behavior.

26. A data signal embodied in a carrier wave comprising: instructions for receiving objects transmitted by carrier wave and a volatility surface-related data including:
(a) option-related data for a selected option chain;
(b) a plurality of parameters that summarize a theoretical implied volatility surface; and
(c) data for displaying a first table representing the theoretical implied volatility surface and contemporaneously displaying a second table representing a market implied volatility surface.
